(19) United States
(12) Patent Application Publication
(10) Pub. No.: US 2015/0309777 A1
(43) Pub. Date: Oct. 29, 2015

(54) METHOD OF CALL CONTEXT ENCODING

(71) Applicant: Plumbr OÜ, Tartu (EE)

(72) Inventors: Nikita SALNIKOV-TARNOVSKI, Tartu (EE); Vladimir Sor, Tartu (EE)

(73) Assignee: Plumbr OÜ, Tartu (EE)

(21) Appl. No.: 14/260,706

(22) Filed: Apr. 24, 2014

(51) Int. Cl. G06F 9/45

(52) U.S. Cl. CPC G06F 8/443

(57) ABSTRACT

The present invention provides methods, systems and computer-program products in support of dynamic calling context encoding, in which call graph evolution is recorded in parallel with call events. In part, this can enable a calling context to be encoded on the fly at a low processing overhead without advance knowledge of the complete call graph.

### FIELD OF THE INVENTION

The invention relates to encoding the call context of routines executed during the operation of a computer program. In particular, the invention relates to the ongoing encoding of stack traces in stack-based virtual machines which run bytecode, e.g. on an application running on a Java® virtual machine (JVM) or Common Language Runtime (CLR) virtual machine.

### BACKGROUND TO THE INVENTION

It is desirable to record events (e.g. object allocation, method calls, etc.) that occur during execution of computer program (e.g. an executable application; more generally, as the context suggests, “application”) in order to monitor running of the application and enable the source of any problems to be subsequently identified. For effectively troubleshooting it is desirable to known when certain events happen and where in the computer program's methodology or functionality those events occurred or were triggered.

However, it may not be enough simply to know the name of the class and/or function or even the exact line of source code where an event has happened. In any non-trivial application the knowledge of source code line which triggers some event is normally insufficient to reason why this event has happened. Thus, it is common practice in the software industry to use the event's stack trace to describe what particular execution path has lead the program to the point which has triggered the event.

Recording and processing information about the functioning of a computer program whilst also running that program brings an unwanted processing overhead. Accordingly, it is desirable for the recording algorithm to interfere as little as possible with the execution of the host program. This is especially true when the events of interest are frequent during program execution, e.g. new object creation events.

In order to minimise the overhead, execution path profiling algorithms have been developed which can record sufficient information very fast. The recorded information can be processed later, either offsite, after program has already terminated, or in parallel with program execution but in separate threads, out of the program's critical path.

A known example of such an algorithm provides a means for encoding any execution path of an application in a single number, known as a calling context identifier or id, and a means for decoding the calling context id back to the execution path that generated it [1]. A similar algorithm has been developed for interprocedural cases [2]. The latter algorithm requires knowledge of the whole calling graph of the application in advance and requires the application code to be instrumented before running the application itself.

### SUMMARY OF THE INVENTION

At its most general, the present invention provides a dynamic calling context encoding method in which call graph evolution is recorded in parallel with call events. This may enable calling context to be encoded on the fly at a low processing overhead without advance knowledge of the complete call graph.

It is undesirable from a programming point of view to use a calling context encoding algorithm that requires full knowledge of the call graph in advance. Such an approach is very cumbersome for software developers and also requires significant changes in work processes of the software providers, who are the most probable end-users of this algorithm in industrial settings. Moreover it is also very costly in terms of amount of computation to generate such full graph in advance. The present invention may ameliorate these disadvantages by providing a calling context encoding method which is applicable for working developers and Java® application developers in particular.

According to the invention there is provided a computer-implemented method of encoding a calling context of a called function in an execution flow of a computer program on a computer having a processor and a memory, the method comprising: receiving into the processor caller information and an encoded calling context identifier for a called function of a computer program; determining, using code executing in the processor, whether or not a current calling graph for the computer program has changed; if there is no change to the current calling graph, storing the called function and the encoded calling context identifier in the memory in association with the current calling graph, if there is a change to the current calling graph, storing the called function and the encoded calling context identifier in the memory in association with an updated calling graph, wherein the updated calling graph corresponds to the current calling graph after the change has been made; and outputting from the processor the encoded calling context identifier in association with either the current calling graph of the called function or the updated calling graph of the called function.

The method may be implemented by a suitably programmed computer in which the computer has a processor which is programmed by having code executing therein to configure the processor so as to implement the functionality and method steps herein described. To be clear, reference to “storing” means storing in non-transitory computer memory, and reference to “determining” means ascertaining an outcome based on logical processing steps performed by a computer processor, which again are steps performed by the processor having been configured by code to execute the application or any part thereof. Preferably, the method is incorporated as part of the computer program itself. For example, if the computer program is a Java® virtual machine application, the method may be implemented via byte code instrumentation using callbacks.

Herein “current calling graph” means a most recent version of a calling graph for the computer program that is available. As explained below, the calling graph in the present invention may be stored as a series of incremental changes from an initial state (e.g. simply an entry point). The most recent version of the calling graph may thus be version of the calling graph that is obtained by applying in sequence all of the stored incremental changes. The incremental changes may be stored in a calling graph evolution log. The method may include recording the determined change to the current calling graph as a new incremental change in the calling graph evolution log.

The encoded calling context identifier may be obtained using any suitable encoding algorithm, such as a Ball-Larus path encoding type algorithm.

Determining whether or not a current calling graph has changed may comprise comparing the caller information with stored caller information for previously called functions. The caller information may include a callee identifier (i.e. a means of identifying the destination node, or desired method or function) and an originating callsite identifier (i.e. the node from which the call originated).

The change to the current calling graph may be any one or more of an addition of a new node, a change in property of an existing node, and an addition of a new edge.

Storing the called function and the encoded calling context identifier may comprise linking a calling graph version identifier to the called function and the encoded calling context identifier. These pieces of information may be stored in a call event transaction log. The calling graph version identifier may be indicative of or may specify the latest incremental change to the calling graph at the time the call was made. This may enable a calling graph that existed at the point when the calling context identifier was encoded to be regenerated in future by applying the incremental changes up to the specified incremental change (but not beyond it)

The method may thus include modifying the calling graph version identifier if there is a change to the current calling graph. The calling graph version identifier may be an ascending number or a time stamp or any other suitable label.

Storing the called function and the encoded calling context identifier may require 64 or fewer bits. Preferably, storing the called function, the encoded calling context identifier and the calling graph version identifier requires 64 or fewer bits. The method may therefore present a low overhead cost in the context of running the computer program.

The present invention may also provide a means for decoding its encoded calling contexts. The decoding step may happen after the computer program has executed the corresponding function. The decoding may occur on a separate processing device (e.g. a remote computer). The invention may provide for communicating the calling graph evolution log and call event transaction log to a remote location.

According to another aspect of the present invention, there is provided a computer-implemented method of decoding a calling context of a called function in an execution flow of a computer program on a computer having a processor, the method comprising: providing a memory accessible to the processor of the computer; receiving a called function, an encoded calling context identifier associated with the called function, and a calling graph version identifier; building, using code executing in the processor, a calling graph that corresponds to the calling graph version identifier; decoding, using code executing in the processor, the calling context identifier based on the calling graph; outputting an execution path based on the decoded calling context identifier and called function.

The step of building a calling graph that corresponds to the calling graph version identifier may comprise extracting a series of calling graph changes from a calling graph evolution log based on the calling graph version identifier, and applying the changes in sequence to an initial calling graph.

The step of extracting the series of calling graph changes from the calling graph evolution log may use a line sweeping replay technique.

### BRIEF DESCRIPTION OF THE DRAWINGS

An embodiment of the invention is discussed below in detailed with reference to the accompanying drawings, in which:

FIG. 1 is a diagram of a calling graph at a first time point;

FIG. 2 is a diagram of the calling graph of FIG. 1 at a second time point, following the identification of a new node;

FIG. 3 is a diagram of another calling graph and associated calling context id values; and

FIG. 4 is a flow chart depicting the steps in a method that is an embodiment of the invention.

### DETAILED DESCRIPTION; FURTHER OPTIONS AND PREFERENCES

The present invention provides a method for encoding an execution path in a calling graph into a calling context identifier in the situation where the calling graph may change over time. A dynamically changing calling graph is common in any typical Java® application. Java® virtual machines use a dynamic class loading mechanism to load some parts of the application into computer memory only when they are to be executed for the first time. As a result, the calling graph of the application can change in the arbitrary moment during application execution. Although the example given below relates to a JVM application, the present invention may be applicable to a program (i.e., an application) run on any type of stack-based virtual machine (e.g. CLR or JVM).

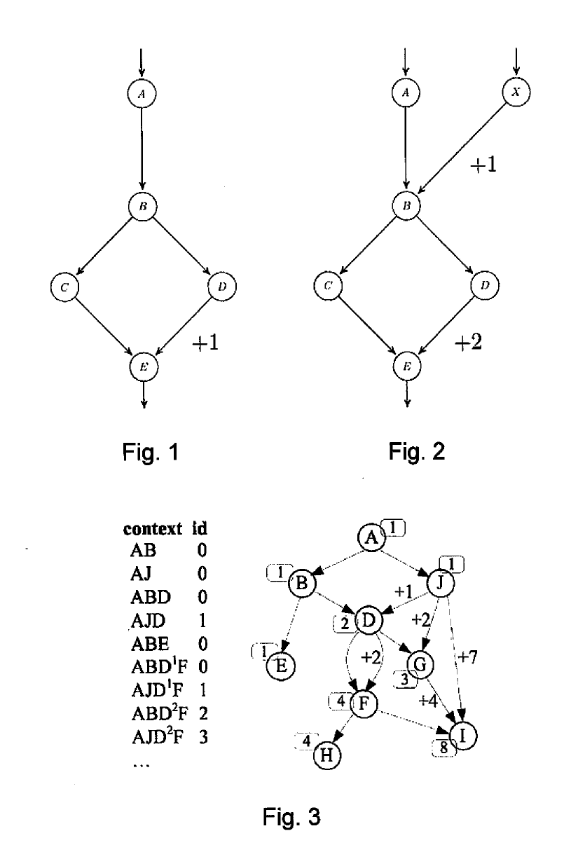

FIGS. 1 and 2 illustrate this situation. FIG. 1 illustrates a calling graph at a first point in time. Given this call graph, the execution path A→B→D→E will be encoded into the value of 1 based on the encoding algorithm discussed below. FIG. 2 shows a calling graph for the same program at a second point in time, later than the first point in time. Here a new edge appears: X→B. If the same encoding algorithm is applied to this calling graph, the calling context id 1 for method E actually represents the execution path X→B→C→E.

The present invention solves this problem by keeping track of changes in the calling graph and by associating a current version of the calling graph with each calling event using code executing in the processor. Thus each recorded calling context id is associated with a contemporaneous version of the calling graph. In practice, the method may generate a calling graph evolution log which records each change to the calling graph with a timestamp. Thus, the relevant calling graph for any given calling event can be built from the calling graph evolution log based on the time at which the calling event occurred.

By associating each calling event with a respective version of the calling graph using code executing in the processor, the method may be utilize further executable code based around an encoding algorithm that relies on the calling graph being known, such as the Ball-Larus path encoding algorithm [1], and which—like all algorithms and functions disclosed herein—can comprise code executable within the processor to configure the processor.

The calling context encoding algorithm used in the present invention may be defined as follows:

### DEFINITION 1

A call graph (CG) is a pair (N,E) and can be represented in implementations of the invention as data stored in memory. N is a set of nodes with each node representing a function. E is a set of directed edges. Each edge eεE is a triple (n,m,l), in which n,mεN, represent a caller and callee, respectively, and l represents a call site where n calls m.

In the above definition of call graph, call edges are modelled as a triple instead of a caller and callee pair because we want to model cases in which a caller may have multiple invocations of the callee.

### DEFINITION 2

The calling context of a given function invocation in, CCₘ is a path in the CG leading from the root node to the node representing m. All possible calling contexts of a given function m is a set {CCₘ}, and the set is defined by code executing within the processor and managed within the memory of the computer implementing embodiments of the invention.

### DEFINITION 3

A valid calling context encoding scheme is a function En:CC→Z⁺ such that ∀nεN, ∀x,yε{CCₙ}, x≠y [symbol] En(x)≠En(y). This function is defined by code executing within the processor and managed within the memory of the computer implementing embodiments of the invention

### DEFINITION 4

Callers of mεN is an ordered collection p(m)={nεN|∃l, <n,m,l>εE}. The order of elements of p is fixed for a given CG. This data is defined by code executing within the processor and managed within the memory of the computer implementing embodiments of the invention.

### DEFINITION 5

Let numCC be a function numCC:N→Z⁺, such that numCC(n)=|{CCₙ}|. It is easy to see that numCC(n)=1 if n is a root node of CG, and

$$num CC ( n ) = {\sum }_{m ∈ p ( n )}^{ } numCC ( m )$$

otherwise.

In [2], the following encoding algorithm was proposed. If nεN is a root node, then En(n)=0. Each edge e=(pᵢ(m),m,l)εE is annotated with value

$${s}_{e} = {\sum }_{{p}_{j} ∈ p ( m ) , j > i}^{ } numCC ( {p}_{j} ) .$$

While making calls during program execution, the value of the current calling context is increased by sₑ during traversing edge e from caller to callee. On returning from callee back to the caller, the value of the current calling context is decreased by sₑ. The foregoing actions are implemented using code executing in the processor.

FIG. 3 is an example of a call graph that demonstrates the above encoding process and its result in one implementation. Each node is annotated with its numCC value, and each edge is annotated with its sₑ value where it differs from 0.

FIG. 3 also list the execution path associated with the calling context id of nodes B, D, E and F. Table 1 sets this out in more detail.

TABLE 1
Calling context associated with calling graph
shown in FIG. 3

| Callee | Calling context id | Execution path |
|---|---|---|
| B | 0 | AB |
| J | 0 | AJ |
| D | 0 | ABD |
| D | 1 | AJD |
| E | 0 | ABE |
| F | 0 | ABD¹F |
| F | 1 | AJD¹F |
| F | 2 | ABD²F |
| F | 3 | AJD²F |

It can be seen from this graph that the callee id and calling context id uniquely identify the execution path for the method.

The above methodology described how to encode calling context where some events, which are of interest to the application observer, have taken place. The following algorithm is able to decode the result of the encoding step, i.e. give the sequence of call sites of an execution path from the callee id and the calling context id.

Algorithm 1: Decoding full calling context

```
Input: the encoded call context value id, the function (i.e.
  callee) m at which the encoding was emitted
Output: full call context cc
  function DECODE(id, m)
    cc ← “m”
    n ← m
    while n ≠ root do
      for i = 0 ...|p(n)| − 1 do
        e ← [symbol]   pᵢ(n),n,l [symbol]
        e′ ← [symbol]   pᵢ₊₁(n),n,l [symbol]
        if sₑ ≦ id ≦ s_{e′} then
          cc ← “l” · cc
          id ← id − sₑ
          break
        end if
      end for
      n ← pᵢ(n)
    end while
end function
```

The above encoding and decoding methodology demonstrates the problem of having a dynamic calling graph. This is because for every given node nεN, the value of numCC(n) can change when new edges emerge in the graph. This leads to changes in sₑ value and thus to different results of both encoding and decoding algorithms.

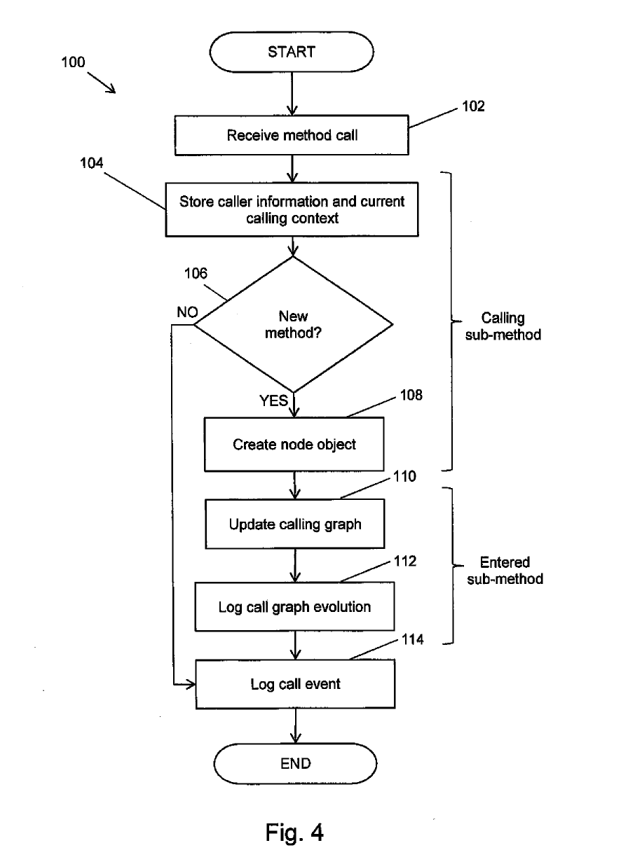

FIG. 4 is a flow chart that depicts a calling context encoding process implemented using a processor, a memory, and code configured as described herein that is an embodiment of the invention. The process actually encompasses two subsidiary methods, which are referred to herein as the “calling” sub-method and the “entered” sub-method. The application is arranged to perform the calling sub-method before the entered sub-method, as explained below.

The calling sub-method occurs whenever the application is going to call some method/function. The calling sub-method itself comprises (i) calling the desired method or function of the algorithm (i.e. identifying the callee), (ii) identifying the callsite (i.e. node on the calling graph) where the method execution originates, and (iii) obtain a value for the calling context based on the current status of the calling graph.

The entered sub-method occurs when application has just entered (i.e. called) a new (i.e. not previously executed or not currently recognised) method. The entered sub-method comprises (i) updating the calling graph, and (ii) passing on the id of the method just entered. Following this step, the decoding algorithm will return the new value of the calling context based on the callee and calling context value provided at the calling step.

The order of the sub-methods is important because the calling context id generating algorithm cannot update the current calling context until a new method is actually called, i.e. the calling context id cannot be determined before an actual invocation. This is due to a heavy usage of polymorphism and dynamic dispatch via late binding in Java® language. At any time before a method invocation it is generally impossible to be sure which exact method by which exact class will be called. This information is available only after JVM has performed method resolution and has determined the exact code to be invoked, e.g. using MethodHandlers in JDK7. Trying to hook into the method resolution process is too error prone or would require a lot of extra work to adapt to any given resolution mechanism.

The present invention thus encompasses the idea that the encoding algorithm implemented by the processor has the processor configured to be notified about a new method on the stack when that new method is already there.

In order to determine whether or not a called method is recognised (i.e. falls on the current calling graph) or is new (i.e. represents a change to the current calling graph) it is necessary to know information about the caller of the method in addition to the callee and the calling context id. This information is provided by the calling sub-method outlined above. It must precede each method invocation in order to store the caller information to be consumed when the new method is entered.

Turning to FIG. 4, the encoding process 100 of the invention begins with a step 102 of receiving a call for a method or function. The method call provides caller information (i.e. a method id (or callee id) and originating callsite) and an encoded value of the calling context obtained by applying the algorithm described above. Thus, for the method call X→B→C→E outlined above with respect to FIG. 2, the caller information would be: callee=E, originating callsite=X, and encoded calling context=1. This information is stored in step 104 to be used in the entered sub-method later.

At step 106, it is determined whether or not the receiving method call is new. If the algorithm has not seen the method before, or the details of the method call are new, the process continues with step 108, where metadata for that method is created (or updated) in the form if a node object. The node object has three fields:
1. id—unique id of the method.
2. numCC—the number of different ways the program execution can reach this method in the currently known calling graph, i.e. a stored version of the calling graph.
3. callers—list of all known callers of this method. The calling sub-method initializes this field to an empty list for a new method.

Following creation of a new node object, the process continues with step 110, where the entered sub-method commences with a step of updating the calling graph. numCC is updated along with calling graph evolution. For each method it is 0 in the beginning and is incremented when a new path to the method is detected. It can be understood from the discussion above with respect to FIGS. 1 and 2 that the presence of a new or updated node in the calling graph affects the assignment of calling context id values. Accordingly, the entered process updates the calling graph using the caller information stored at step 104 to update the calling graph so that the encoding calling context provided with the method call received at step 102 can be associated with a contemporaneous calling graph. By matching the calling context id with the appropriate calling graph upon decoding, the calling context id will map to the actual execution path used.

In step 110, the process updates the calling graph, e.g. by adding or changing a node or an edge in the graph, and in step 112 the process records the event in a suitable log file. The process thus incrementally encodes the stack traces by logging the changes to the preceding calling graph. The following algorithm may be used to implement steps 110 and 112.

Algorithm 2: Update calling graph

```
Input: id of the caller function callerId, id of the current
  function (i.e. callee) calleeId, current call graph graph
Output: call graph updated with new information
  function UPDATE(callerId, calleeId, graph)
    callee ← graph.get(calleeId)
    if callee = null then
      graph, addNode(calleeId)
      recordEvent(“nodeAdded”)
    end if
    for caller in callee.callers do
      callee, numCC+= caller.numCC
      if caller.id = callerId then
        oldCaller ← “true”
      end if
    end for
    if oldCaller = “false” then
      graph, addEdge (calleeId, callerId)
      recordEvent(“edgeAdded”)
    end if
  end function
```

The process then continues with a step 114 of logging the call event received at step 102. The call event is logged by stored the callee id (i.e. the method or function that is called), the encoded calling context id, and the data indicative of the version of the calling graph that is relevant to the calling context id. This may be a version number or a time stamp that can be referenced to the calling graph evolution log that is produced by the output of step 112. The logged information may be stored e.g. in a low latency manner, in computer memory or on persistent storage, e.g. a hard disk or the like.

Similarly, if the received method call is determined to be recognised at step 106, the process may bypass the entered sub-method and proceed directly to logging the call event at step 114.

Thus, with every recorded encoded value of the calling context the process according to the invention effectively stores a version of the calling graph that was in existence at the time of this encoding. When the decoding the calling context it is thus possible to “replay” the logged graph changing events that occurred before the time of the relevant calling event. For example, the replay process may be implemented using known line sweeping event replay techniques. In this way decoding will always happen on exactly the same graph as corresponding encoding.

The process outlined can be implemented at low overhead cost because the encoding can still be achieved with a limited number of bits (e.g. 64 bits or fewer for each call event).

The process outlined above may be implemented within the execution flow of existing applications using conventional Java® techniques and by outputting appropriate information, such as calling context identifiers or execution paths to a memory or to the processor. For example, the relevant calling events with the execution flow may be detected using bytecode instrumentation with callbacks. Bytecode instrumentation enables new code to be added in a transparent way without modifying source code of the existing program.

### REFERENCES

[1] Thomas Ball and James R. Larus. Efficient path profiling. In Proceedings of the 29th Annual ACM/IEEE International Symposium on Microarchitecture, MICRO 29, page 4657, Washington, D.C., USA, 1996. IEEE Computer Society.
[2] William N. Sumner, Yunhui Zheng, Dasarath Weeratunge, and Xiangyu Zhang. Precise calling context encoding. In Proceedings of the 32nd ACM/IEEE International Conference on Software Engineering—Volume 1, ICSE '10, page 525534, New York, N.Y., USA, 2010. ACM.

1. A computer-implemented method of encoding a calling context of a called function in an execution flow of a computer program on a computer having a processor and a memory, the method comprising:
receiving into the processor caller information and an encoded calling context identifier for a called function of a computer program;
determining, using code executing in the processor, whether or not a current calling graph for the computer program has changed;
if there is no change to the current calling graph, storing the called function and the encoded calling context identifier in the memory in association with the current calling graph;
if there is a change to the current calling graph, storing the called function and the encoded calling context identifier in the memory in association with an updated calling graph; wherein the updated calling graph corresponds to the current calling graph after the change has been made; and
outputting from the processor the encoded calling context identifier in association with either the current calling graph of the called function or the updated calling graph of the called function.

2. A method according to claim 1, further comprising recording the change to the current calling graph in a calling graph evolution log.

3. A method according to claim 1, wherein the encoded calling context identifier is set using a Ball-Larus path encoding type algorithm.

4. A method according to claim 1, wherein determining whether or not a current calling graph has changed comprises comparing the caller information with stored caller information for previously called functions.

5. A method according to claim 1, wherein the caller information includes a callee identifier and an originating callsite identifier.

6. A method according to claim 1, wherein the change to the current calling graph is an addition of a new node.

7. A method according to claim 1, wherein the change to the current calling graph is a change in property of an existing node.

8. A method according to claim 1, wherein the change to the current calling graph is an addition of a new edge.

9. A method according to claim 1, wherein storing the called function and the encoded calling context identifier comprises linking a calling graph version identifier to the called function and the encoded calling context identifier.

10. A method according to claim 10, further comprising modifying the calling graph version identifier if they is a change to the current calling graph.

11. A method according to claim 1, wherein the computer program is an application executed by a Java® virtual machine (JVM).

12. A method according to claim 1, wherein storing the called function and the encoded calling context identifier requires 64 or fewer bits.

13. A method according to claim 9, wherein storing the called function, the encoded calling context identifier and the calling graph version identifier requires 64 or fewer bits.

14. A computer-implemented method of decoding a calling context of a called function in an execution flow of a computer program on a computer having a processor, the method comprising:
providing a memory accessible to the processor of the computer;
receiving a called function, an encoded calling context identifier associated with the called function, and a calling graph version identifier;
building, using code executing in the processor, a calling graph that corresponds to the calling graph version identifier;
decoding, using code executing in the processor, the calling context identifier based on the calling graph;
outputting an execution path based on the decoded calling context identifier and called function.

15. A method according to claim 14, wherein building a calling graph that corresponds to the calling graph version identifier comprises extracting a series of calling graph changes from a calling graph evolution log based on the calling graph version identifier, and applying the changes in sequence to an initial calling graph.

16. A method according to claim 15, wherein extracting the series of calling graph changes from the calling graph evolution log uses a line sweeping replay technique.

17. A method according to claim 14, wherein the computer program is an application executed by a Java® virtual machine (JVM).

18. A computer program product comprising a non-transitory storage media having computer executable instructions stored thereon, wherein the computer executable instructions, when executed in a computer, cause the computer to perform a method of encoding a calling context of a called function in an execution flow of a computer program, the method comprising:
receiving caller information and an encoded calling context identifier for a called function of a computer program;
determining whether or not a current calling graph for the computer program has changed;
if there is no change to the current calling graph, storing the called function and the encoded calling context identifier in association with the current calling graph,
if there is a change to the current calling graph, storing the called function and the encoded calling context identifier in association with an updated calling graph, wherein the updated calling graph corresponds to the current calling graph after the change has been made.

19. A computer program product comprising a non-transitory storage media having computer executable instructions stored thereon, wherein the computer executable instructions, when executed in a computer, cause the computer to perform a method of decoding a calling context of a called function in an execution flow of a computer program, the method comprising:
receiving a called function, an encoded calling context identifier associated with the called function, and a calling graph version identifier;
building a calling graph that corresponds to the calling graph version identifier;
decoding the calling context identifier based on the calling graph;
outputting an execution path based on the decoded calling context identifier and called function.
